(19) United States
(12) Patent Application Publication
(10) Pub. No.: US 2005/0144353 A1
(43) Pub. Date: Jun. 30, 2005

(54) Wireless virtual storage device

(75) Inventors: Ou Jui Long, Hsinchu (TW); Chen Chin Feng, Hsinchu (TW)

Correspondence Address: ANTHONY R BARKUME, 20 GATEWAY LANE, MANORVILLE, NY, 11949, US

(73) Assignee: Z-Com, Inc.

(21) Appl. No.: 10/960,668

(22) Filed: Oct. 7, 2004

(30) Foreign Application Priority Data
Dec. 31, 2003 (TW) 092137563

(51) Int. Cl. G06F 12/00

(52) U.S. Cl. 711/100

(57) ABSTRACT

A wireless virtual storage device comprises an interface having a plug and play feature for connecting with a host PC; a wireless network unit for supporting a wireless network accessing feature and accessing with a wireless network; and a control unit for communicating with the interface and the wireless network unit, and executing a network file system software to access a network file system on the wireless network by the wireless network unit in order to support the host PC to get the access control of the network file system's storage media via the interface.

### FIELD OF THE INVENTION

The present invention relates to a wireless virtual storage device, especially to combine with USB Dongle flash disk and providing USB Dongle wireless feature, which is able to support an external host PC to access the wireless virtual USB flash disk of the network file system on the wireless network by executing the network file system software via USB interface.

### BACKGROUND OF THE INVENTION

The portable storage devices such as different types of USB flash disks, are very popular for several applications and usages due to their small space and easy portability. Although there are so many advantages of USB flash disks, they also comprise some disadvantages:
1. Limitation of storage size: in current market, the storage space of the USB flash disks can be up to millions of Mega bytes due to the built-in or plugged flash memory (in general, the storage size is 128 MBytes or 256 Mbytes). It will be very inconvenient to use a USB flash disk to store huge amount of data.
2. Not easy for multi share: every user will have a copy of local data under multi share status. If users need to share the same data, data version will not be easy to control.

Based on the convenience of data exchange and share, it will be very convenient by using WLAN (Wireless Local Area Network). However, USB Dongle WLAN can only support the basic WLAN access feature for the plugged host PC; for accessing the file data from the WLAN, this host PC has to comprise the supporting of network file system software for itself.

Because of the extremely request of the USB Dongle flash disk in the current market, if we can combine with the WLAN accessing feature of USB Dongle WLAN and solve the disadvantages of storage size limitation and multi data sharing, we should be able to enhance the characteristics and features of this type of product.

### SUMMARY OF THE INVENTION

An objective of the present invention is to provide a solution that uses software to combine with the network disk and the file architecture together as a virtual flash disk with WLAN feature, and increases a using mode on the USB WLAN products.

Another objective of the present invention is, under this new mode, the usage still likes a general USB flash disk, but the real storage device is located at the remote storage media of the network file system.

Another objective of the present invention is to solve the disadvantages of storage size limitation and inconvenience of data multi sharing of the traditional USB flash disks.

### BRIEF DESCRIPTION OF THE INVENTION

According to the present invention, a wireless virtual storage device comprises:

an interface having a plug and play feature for connecting with a host PC;

a wireless network unit for supporting a wireless network accessing feature and accessing with a wireless network; and

a control unit for communicating with the interface and the wireless network unit, and executing a network file system software to access a network file system on the wireless network by the wireless network unit in order to support the host PC to get the access control of the network file system's storage media via the interface.

In accordance with one aspect of the present invention, the interface can be a serial interface, and the serial interface can be a USB (Universal Serial Bus) interface.

In accordance with one aspect of the present invention, the wireless network unit can be a WLAN (Wireless Local Area Network) Unit.

In accordance with one aspect of the present invention, the control unit comprises a memory for storing the network file system software.

In accordance with one aspect of the present invention, the control unit also comprises a storage media controller to read the network file system software in the memory to execute, and access the network file system on the wireless network via the wireless network unit, so as to support the host PC to get the access control of the network file system's storage media via the interface.

In accordance with one aspect of the present invention, the storage media controller is a flash memory controller.

In accordance with one aspect of the present invention, the network file system's storage media could be a remote storage.

In accordance with one aspect of the present invention, the device could be a wireless virtual USB flash disk.

The present invention may best be understood through the following description with reference to the accompanying drawings, in which:

### BRIEF DESCRIPTION OF THE DRAWINGS

FIG. 1 shows the system block diagram of the wireless virtual storage device according to the present invention.

### DETAILED DESCRIPTION OF THE PREFERRED EMBODIMENT

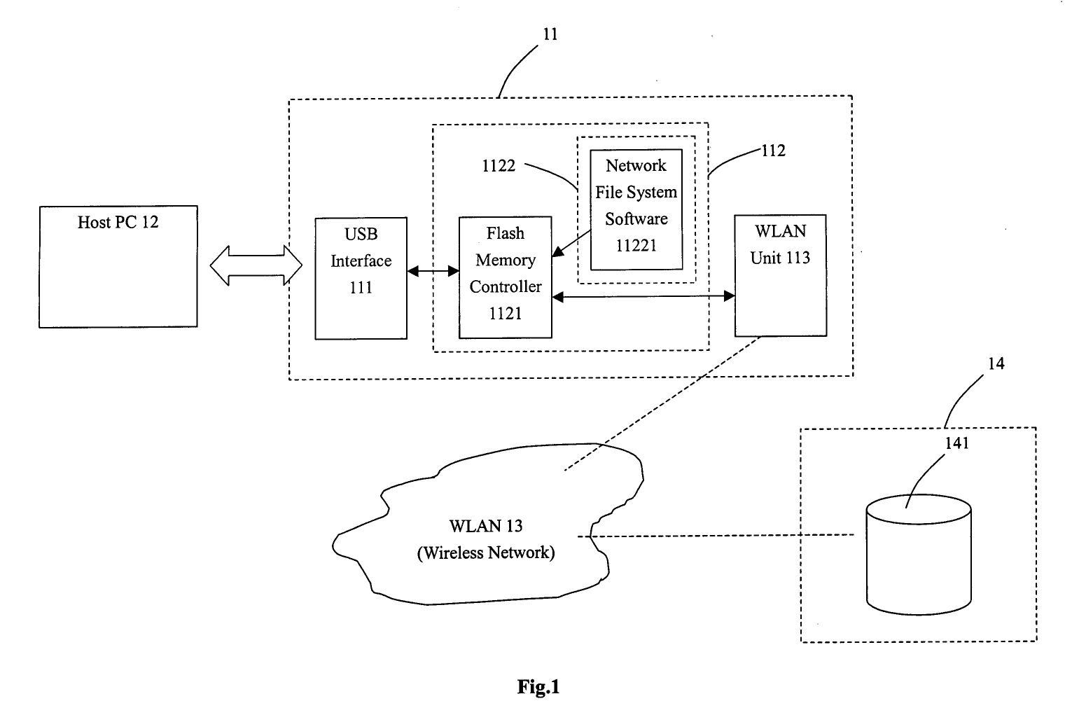

FIG. 1 shows the system block diagram of the wireless virtual storage device according to the present invention. In this figure, the wireless virtual storage device is a wireless virtual USB flash disk 11 and comprises a USB Interface 111, a control unit 112, and a WLAN unit 113. In the present invention, the USB interface 111 is able to support the plug and play feature, that is able to electrical connect with an external host PC 12 for data transmission. The WLAN unit 113 is able to support wireless network accessing feature. The control unit 12 is able to communicate with USB interface 111 and WLAN unit 113, and comprises a virtual flash memory controller 1121 and a memory 1122 having a network file system software 1122.

The usage of the wireless virtual USB flash disk 11 provides the host PC 12 to access the remote storage 141 through the wireless network 13 by USB interface 111, and is as convenient as a traditional USB flash disk, and it is not necessary to install the driver of WLAN unit 113 for network accessing due to the plug and play feature of the host PC 12. The electrical theory of the wireless virtual USB flash disk 11 is, when the USB interface 111 is plugged into the host PC 12, virtual flash memory controller 1121 can be able to read the source codes of the network file system software 11221 in the memory 1122 and executes it. The network file system software 11221 can be able to use WLAN unit 113 to access the remote storage 141 of the network file System 14 through the wireless network 13. At this moment, by executing the network file system software, the host PC 12 is able to access the remote storage 141 by virtual accessing the flash disk via USB interface 111. The control unit 112 can communicate with USB interface 111 and the WLAN unit 113.

Of course, the control unit 112 can be designed to meet the real requirements. But, any unit that comprises the controlling feature for the storage media such as the virtual flash memory can be used as a control unit 112 to access a file of the host PC 12 through the wireless network 13 by the network file system software 11221. The control unit 12 comprises a memory to store the network file system software and is able to execute it so as to access the remote storage 141 of the network fie system 14 as the traditional access method of flash disk. Therefore, the host PC 12 can access network file system 14 connecting to the wireless network 13 via USB interface 111 and the WLAN unit 113. All what the host PC 12 accesses the network file system 14 by means of traditional interfaces such as USB, CF, SD, miniSD, and etc., through a WLAN unit 113 connecting to a wireless network 13 are belonged to the disclosure of the present invention.

To sum up, the present invention improves the traditional technique by the software solution, to combine the network disk with the file architecture as a wireless virtual storage device. If using the technique of USB interface and flash memory controller, then the usage will be the same as a general USB flash disk, but the real storage device is located at the remote storage in the network file system from the wireless network. The advantage of the present invention is, to store the data into the remote storage media but not the entity of this device to improve the storage size limitation of the general USB flash disk, and also to provide multiple sharing functions for the stored data and to keep an exact data version in the file system. Above all, the usage is still the same as a general USB flask disk so as to access the remote storage of the wireless network by wireless network accessing. The present invention is such a portable storage device to provide users more flexibilities and storage spaces.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A wireless virtual storage device comprising:
an interface having a plug and play feature for connecting with a host PC;
a wireless network unit for supporting a wireless network accessing feature and accessing with a wireless network; and
a control unit for communicating with said interface and said wireless network unit, and executing a network file system software to access a network file system on said wireless network by said wireless network unit in order to support said host PC to get said access control of said network file system's storage media via said interface.

2. The device according to claim 1 wherein said interface can be a serial interface, and said serial interface can be a USB (Universal Serial Bus) interface.

3. The device according to claim 1 wherein said wireless network unit can be a WLAN (Wireless Local Area Network) Unit.

4. The device according to claim 1 wherein said control unit comprises a memory for storing said network file system software.

5. The device according to claim 4 wherein said control unit also comprises a storage media controller to read said network file system software in said memory to execute, and access said network file system on said wireless network via said wireless network unit, so as to support said host PC to get the access control of said network file system's storage media via said interface.

6. The device according to claim 5 wherein said storage media controller is a flash memory controller.

7. The device according to claim 1 wherein said network file system's storage media is a remote storage.

8. The device according to claim 1 wherein said device is a wireless virtual USB flash disk.
